(19) United States
(12) Patent Application Publication
(10) Pub. No.: US 2008/0244010 A1
(43) Pub. Date: Oct. 2, 2008

(54) PROVIDING MESSAGE CONTENT TO A USER FOR COMPOSING MESSAGES FOR MAILING AT A HAND-HELD PORTABLE ELECTRONIC DEVICE

(76) Inventor: SANJEEV KUMAR SINGH, Houston, TX (US)

Correspondence Address: Sanjeev Kumar Singh, 32 Crows Nest Lane, Unit No. 17, Danbury, CT, 06810, US

(21) Appl. No.: 11/693,130

(22) Filed: Mar. 29, 2007

(51) Int. Cl. G06F 15/16

(52) U.S. Cl. 709/206

(57) ABSTRACT

A method and an apparatus are provided for providing message content to a user at a hand-held, portable electronic device for composing an electronic message. The user may use at least a portion of the message content for composing the electronic message for mailing over a network to a recipient. For example, templates with precomposed content may be provided at a cell phone to compose a message body and/or a subject filed of electronic messages for mailing including electronic mail (e-mail) messages. A template with precomposed content may comprise previously created content for use in a message body including a subject filed of the message. The precomposed content may be selectively editable by a user. By using a messaging application that may be capable of communicating with a server in a network, a user may compose the message, such as a reply to an e-mail with desired message content from one or more of the templates. Use of at least one template with precomposed message content in the messaging application at a hand-held, portable electronic device may enable a user to perform mobile emailing with ease. In one embodiment, a method of enabling electronic messaging using an interactive user interface of a hand-held, portable electronic device is provided. The method comprises providing templates with precomposed message content for use in the interactive user interface to compose an electronic message having at least one of a message body or a signature block. The method further comprises enabling a user to compose the message body of the electronic message with at least a portion of the precomposed message content for delivery to an intended recipient.

### BACKGROUND OF THE INVENTION

1. Field of the Invention

This invention relates generally to enabling message communications at a hand-held, portable electronic device, and more particularly, to providing message content to a user for composing electronic messages for mailing, such as electronic mails at a wireless client device.

2. Description of the Related Art

Increasingly access to networked devices, such as a processor or controller based devices including computers, personal digital assistants (PDAs), and cell phones is becoming widely available. As a result, electronic communication is not only a trend anymore but a norm and convenient way of conveying information including message communications between users of hand-held, portable electronic devices including wireless and/or mobile communication devices. For example, enterprises and Internet Service Providers (ISPs) use Internet to enable exchange of electronic mail (e-mail) over a connected mesh of wired and/or wireless networks. These entities may provide easy access to email services on the Internet or Intranet via mail servers or websites.

To send and receive an e-mail, for example, a user may use electronic messaging software that is also responsible for composing, sending, receiving, storing, replying and forwarding of e-mails in a client-server based system. A computer may be used to compose and transmit e-mail, generally by dial-up telephone connection or a broadband connection, such as a faster cable connection, a Digital Subscriber Line (DSL) connection or a wireless connection to an Internet service provider (ISP) that may provide a mail server, which is generally responsible for receiving e-mail and routing it to the appropriate destination address. A computer may comprise a modem to send or receive electronic messages between an e-mail client and the ISP. In a local area network (LAN) scenario, however, multiple computers may simply be coupled to a server that may host the e-mail server. For a wireless e-mail provider, a cellular network operator may enable a wireless communication between the mail server and a mobile device for providing an e-mail service to a mobile user.

By using a messaging application program executing on a device, for example, a hand-held, portable electronic device a mobile user may compose an e-mail message into a portable computer. The e-mail message may be either first stored or directly transmitted from the portable computer to the ISP using a modem or wireless access point. Upon receiving the e-mail message, a mail server, such as the one hosted and/or managed by the ISP may forward the e-mail message to an appropriate destination for an intended recipient. The messaging application program may provide a user interface, which may enable the user to appropriately format the e-mail message. To compose an e-mail message, the user may employ the user interface of the messaging application program. By using the user interface, the user may enter individual letters or alphabets to compose words, phrases, or sentences to create the e-mail message. Once the message has been fully drafted or composed, it may be transmitted using a conventional modem and a dial-up connection or a local area network connection or a wired/wireless network. Upon reaching a mail server, the e-mail message may be forwarded to the appropriate destination address for delivery to an intended user.

Composing an e-mail message using a messaging application program generally requires a user to create an electronic message body from scratch by entering information such as text from a keyboard and/or a pointing device, such as a mouse. It is not that big of a problem in a laptop computer or a device having a computer keyboard with may be access to a pointing device, such as a mouse. In a wireless e-mail scenario, however, when using a hand-held, portable communication device, such as a cell phone having a typical mobile keyboard it may be inconvenient and a relatively slow process to compose an e-mail message from the scratch by inputting or typing in the entire message content.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a method of enabling electronic messaging using an interactive user interface of a hand-held, portable electronic device is provided. The method comprises providing templates with precomposed message content for use in the interactive user interface to compose an electronic message having at least one of a message body or a signature block. The method further comprises enabling a user to compose the message body of the electronic message with at least a portion of the precomposed message content for delivery to an intended recipient.

In a further embodiment of the present invention, an article comprising a computer readable storage medium storing instructions that, when executed cause a client-server system to enable electronic messaging using an interactive user interface of a hand-held, portable electronic device by providing templates with precomposed message content for use in the interactive user interface to compose an electronic message having at least one of a message body or a signature block and enabling a user to compose the message body of the electronic message with at least a portion of the precomposed message content for delivery to an intended recipient.

### BRIEF DESCRIPTION OF THE DRAWINGS

The invention may be understood by reference to the following description taken in conjunction with the accompanying drawings, in which like reference numerals identify like elements, and in which:

FIG. 1 schematically illustrates a client-server system that enables a user of a hand-held, portable electronic device to perform mobile mail messaging using one or more templates with precomposed message content in accordance with one illustrative embodiment of the present invention;

FIG. 2 schematically illustrates an interactive user interface of a messaging application shown in FIG. 1 for composing an electronic mail message using desired message content from at least one of the templates consistent with one exemplary embodiment of the present invention;

FIG. 3 schematically illustrates a communication system including a wireless network to communicate the electronic mail message from a cell phone including an e-mail client module of the messaging application program capable of communicating with a mail server according to one illustrative embodiment of the present invention;

FIG. 4 schematically illustrates a stylized representation for implementing a method of enabling electronic messaging using the interactive user interface shown in FIG. 2 of the hand-held, portable electronic device shown in FIG. 1 in accordance with an exemplary embodiment of the present invention; and

FIG. 5 schematically illustrates a stylized representation for implementing a method of selectively providing a list of templates suitable for composing the electronic message using generic or user populated content consistent with an illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Generally, a method and an apparatus are provided for providing message content to a user at a hand-held, portable electronic device for composing an electronic message. The user may use at least a portion of the message content for composing the electronic message for mailing over a network to a recipient. For example, templates with precomposed content may be provided at a cell phone to compose a message body including a subject filed of electronic messages for mailing including electronic mail (e-mail) messages. A template with precomposed content may comprise previously created content for use in a message body and/or a subject filed of the message. The precomposed content may be selectively editable by a user. Use of at least one template with precomposed message content in a messaging application at a hand-held, portable electronic device may enable a user to perform mobile emailing with ease. By using the messaging application that may be capable of communicating with a server in a network, a user may compose the message, such as a reply to an e-mail with desired message content from one or more of the templates. In one embodiment of the present invention, a method of enabling electronic messaging using an interactive user interface of a hand-held, portable electronic device is provided. The method comprises providing templates with precomposed message content for use in the interactive user interface to compose an electronic message having at least one of a message body or a signature block. The method further comprises enabling a user to compose the message body of the electronic message with at least a portion of the precomposed message content for delivery to an intended recipient. For example, a computer system or a hand-held, portable device capable of executing a messaging application program such as an e-mail or instant messaging application software program may provide an option to include the desired content from the predefined content that may be reused in a wide variety of ways by different messages. In one embodiment, the message content templates may accommodate a user response of certain generic or previously user created content in reply to an e-mail message or composing an outbound e-mail message. In one embodiment, a conventional client-server architecture based e-mail system may enable a user to create e-mail messages form readily accessible predetermined text, audio, video and the like. For composing such a new or reply e-mail, a messaging application program may not require redrafting of the entire message with typing or entry of the entire message content. In a wireless e-mail service scenario, when using a hand-held portable communication device, such as a cell phone, for example, it may become convenient to type only a portion of the entire message content from the scratch. Therefore, a composer of an e-mail may not end up creating the entire body of an electronic mail message from scratch for each and every instance of forming a new e-mail or replying to an e-mail message in an electronic mailbox. In this way, user productivity may not be wasted by repetitive drafting of substantially common and/or generic response content when composing an e-mail dealing with routine message content that quickly conveys a general response or intent form the composer of the e-mail.

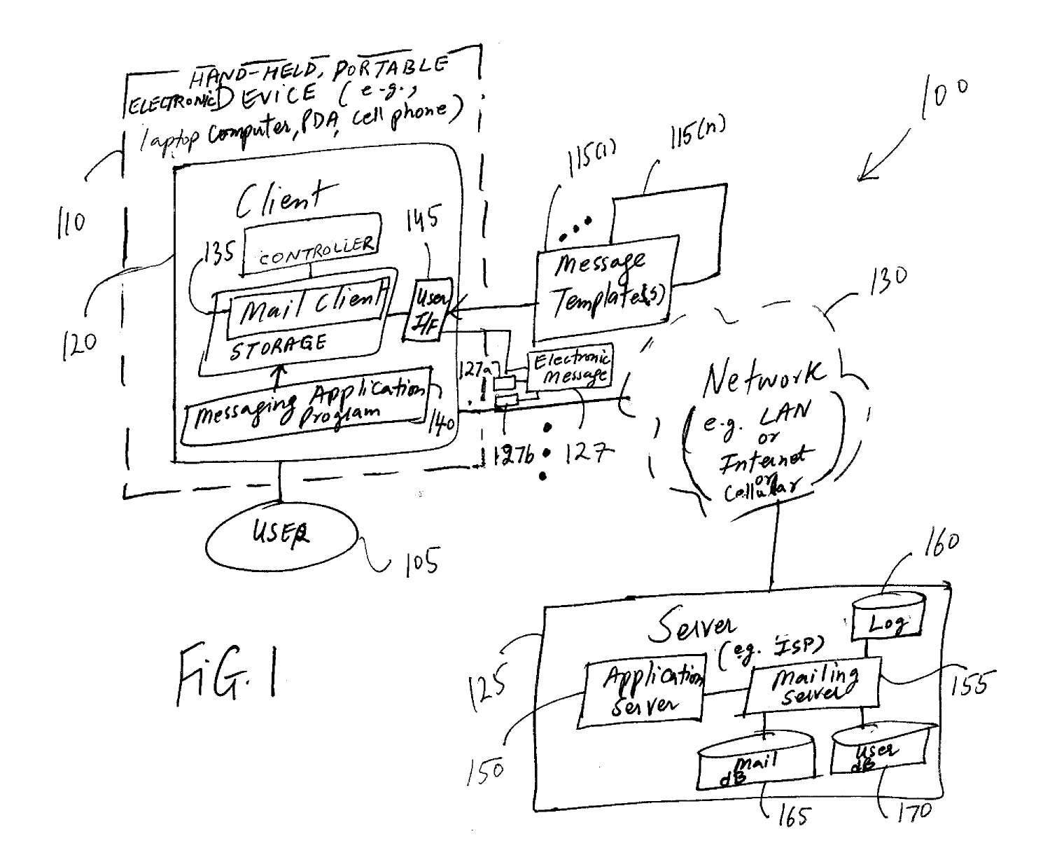

Referring to FIG. 1, a client-server system 100 is schematically illustrated for enabling communications in accordance with one illustrative embodiment of the present invention. The client-server system 100 may enable a user 105 of a hand-held, portable electronic device 110 to perform mobile mail messaging using one or more message templates 115(1-n) with precomposed message content. The user 105 of the hand-held, portable electronic device 110 may exchange electronic messages to communicate with other users of the networked devices wired and/or wireless. By selectively using at least one message template, e.g., the message template 115(1), the user 105 may compose mail messages, such as electronic mails (e-mails) with desired message content at the hand-held, portable electronic device 110.

Examples of the hand-held, portable electronic device 110 include consumer electronics products such as a processor or controller based devices including hand-held, portable or laptop computers, hand-held multi-media players, music players, cellular phones, hand-held wired and/or wireless communication and/or computing devices, hand-held pocket computers, and personal digital assistants (PDAs), a game player, a video player, a video recorder, a camera, an image viewer and the like. The hand-held, portable electronic device 110 may be sized for placement even into a pocket or hand of the user 105 and no reference surface such as a desktop is desired to operate it. By being hand-held, such a portable electronic device may be relatively small and easily handled and utilized by its user. Unlike a computer, by being portable it may be pocket sized; the user may carry the hand-held, portable electronic device 110 in hand and avoid carrying a relatively large bag for a bulky and often heavy device. A battery (not shown), an AC adapter, or a vehicle adapter may power the hand-held, portable electronic device 110. Since the hand-held, portable electronic device 110 is also a battery operated device and being a highly portable, a user may listen to music, play games or video, record video or take pictures or wirelessly communicate wherever the user travels.

Consistent with one embodiment, the hand-held, portable electronic device 110 may comprise a client 120. The client 120 may control the overall operation of the hand-held, portable electronic device 110. The client 120 may communicate with a server 125 over a network 130 to provide an email service to the user 105. The message templates 115(1-n) with precomposed message content may be resident locally in a storage device 132 at the client 120 and/or stored at the server 125. Examples of the message templates 115(1-n) with precomposed message content include a drop-down menu clickable using a pointing device, such as a mouse, a wheel, a stylus, a navigation key, and a touch pad.

In operation, the message templates 115(1-n) may be provided as part of an e-mail editing or composing window on a display screen (not shown) to enable the user 105 of the hand-held, portable electronic device 110 to select one or more message templates 115(1-n) or a portion of a selectively editable precomposed message content when composing an electronic message 127 for mailing, such as an e-mail. By using one or more of the message templates 115(1-n) with precomposed message content, the user 105 may compose the electronic message 127 having a message body 127a and/or a signature block 127b. In one embodiment, while the message body 127a refers to the subject matter of the electronic message 127, the signature block 127b refers to contact information of the user 105. For example, to compose the message body 127a of the electronic message 127 with at least a portion of the precomposed message content at the hand-held, portable electronic device 110 for delivery to an intended recipient, the user may use a drop-down menu on a touch sensitive display screen clickable with a stylus.

Examples of the client 120 include a controller 134 such as a processor with associated software and/or firmware that controls communication and computing functionality of the hand-held, portable electronic device 110. Examples of the server 125 include an Internet Service Provider (ISP) or an enterprise server capable of provisioning an email service to the user 105 of the hand-held, portable electronic device 110, such as an e-mail server including Microsoft Server 2000® available from Microsoft Corporation of One Microsoft Way, Redmond, Wash. 98052, USA. Examples of the network 130 include one or more wired and/or wireless networks including Internet, a local area network (LAN), and a cellular network.

Over the network 130, the server 125 may allow commercial enterprises, media service providers or network operators, ISPs and businesses to disseminate electronic multi-media content (textual, graphic, music and video files) over a connected mesh of wired and/or wireless network users including the user 105 of the hand-held, portable electronic device 110. For example, several of these entities may provide access to multi-media content and services on the Internet via websites and web browsers.

According to one embodiment, the client 120 at the hand-held, portable electronic device 110 may comprise a mail client 135, a messaging application program 140 and an interactive user interface (I/F) 145. The mail client 135 may communicate with the server 125 over the network 130 to exchange electronic multi-media content (textual, graphic, music and video files). For the purposes of providing an email-service, the client 120 may store and execute the messaging application program 140, such as an e-mail program including Microsoft Outlook® available from Microsoft Corporation of One Microsoft Way, Redmond, Wash. 98052, USA.

While the user interface (I/F) 145 of the hand-held, portable electronic device 110 may comprise a display screen (not shown), the client 120 may be configured to run user applications (APPS) and send outputs of the user applications to the user interface (I/F) 145. For example, the display screen of the user interface 145 may provide a touch sensitive screen for display of Operating System prompts, buttons, icons, application screens, and other data, and for providing user inputs via tapping or touching (or drawing in an area) via a stylus or other touch mechanism. By using the user interface (I/F) 145, the user 105 of the hand-held, portable electronic device 110 may use and/or exchange electronic content such as multi-media content including music, video, electronic mail messages with other wired and/or wireless communication devices. Additionally, the user 105 of the hand-held, portable electronic device 110 may obtain and store a variety of electronic multi-media content such as music and video files on the hand-held, portable electronic device 110.

Consistent with one illustrative embodiment of the present invention, the client 120 may store and execute other user applications (APPS) that may include a phone application (APP), a Personal Digital Assistant (PDA) application (APP), and a Global Positioning System (GPS) application (APP). The phone application may be configured to capture user inputs for telephone related operations and display current telephone operations information on the user interface (I/F) 145. The PDA application may be configured to capture user inputs for PDA related operations and display current PDA operations information on the user interface (I/F) 145. The GPS application may be configured to capture user inputs for location related operations and display current location operations information on the user interface (I/F) 145.

Consistent with one illustrative embodiment of the present invention, the server 125 may comprise an application server 150 coupled to a mailing server 155. In one embodiment, the application server 150 may be a server computer in a computer network dedicated to running certain software applications. The application server 150 may have software installed on the server computer to facilitate the serving (running) of other applications including an application for the mailing server 155. For example, the application server 150 may provide access to a client/server application and, sometimes, the data that belongs to that application. In a multi-tier architecture, the application server 150 may communicate with a web server (not shown) or between a web server and an enterprise information system to provide a middleware platform. The application server 150 may provide a software platform that delivers content to the World Wide Web (WWW) over the Internet. The application server 150 may interpret website traffic and construct web pages based on a dynamic content repository. This content is typically personalized based on site visitor information, such as the content the user 105 has viewed up to that point, the user's 105 past usage history, or preferences the user 105 may have set during previous visits.

In one embodiment, the mailing server 155 refers to a host server which holds e-mail messages for clients including the client 120. The client 120 may use the messaging application program 140 to obtain e-mails for the user 105 in an inbox by connecting to the mailing server 155 to retrieve any messages that may be waiting for the user 105. The mailing server 155 may be a computer devoted to sending, receiving and storing mail. This computer may store and distribute electronic mail (e-mail) messages. This computer at an ISP may handle e-mail coming into a user's account as well as all the e-mail that the user 105 may send out. This computer of an email service provider may direct e-mail messages to and from the hand-held, portable electronic device 110 and send files to a user's e-mail address. The mailing server 155 may include a mail transfer agent (MTA) also called a mail server, or a mail exchange server in the context of the Domain Name System, a computer program or software agent which transfers electronic mail messages from one computer or device to another.

In accordance with one illustrative embodiment of the present invention, the mailing server 155 may maintain a log 160 of various activities of the server 125. For example, the log 160 may indicate e-mail service requests and service responses or events associated with the user 105. The mailing server 155 may maintain a mail database (dB) 165 and a user database (dB) 170. While the mail dB 165 may store electronic mail messages such as emails, the user dB 170 may store user information such as email addresses, user profile, and user contact information, user account information or user subscription information.

According to one illustrative embodiment of the present invention, the client 120 at the hand-held, portable electronic device 110 may be an e-mail client, also called a mail user agent (MUA), which may be a computer program that is used to receive and send e-mail. The MUA may be used for reading the user's 105 mail messages. A mail delivery agent (MDA) in conjunction with a mail transfer agent (MTA) may transfer the mail messages into a local mailbox (not shown) of the user 105. Examples of a mailbox format include a mbox and a Maildir protocol. The client 120 may use these protocols for locally storing e-mails, importing, exporting, and backing up of mail folders. For example, an e-mail to be sent would be handed over to the MTA via a mail submission agent which provides mail transport-related functions.

According to an illustrative embodiment of the present invention, the client 120 may use a Post Office Protocol (POP) to retrieve electronic mail from the server 125. To use the POP, in one embodiment, the client 120 may be a POP-compatible mail client. The POP based client 120 may be a password-authenticated mail client that allows the user 105 to enter a POP server, such the server 125, their username, and their password. However, the client 120 may support protocols including Post Office Protocol (POP3) and Internet Message Access Protocol (IMAP) to communicate with a remote MTA located at the e-mail provider's computer at the server 125. While the IMAP and the updated IMAP4 protocols may be used for storage of e-mail on the server 125, the POP3 protocol may allow the e-mails to be downloaded to the client 120. The Simple Mail Transfer Protocol (SMTP) may be used by the client 120 having an e-mail client to send an e-mail. In addition or alternatively, the client 120 may use a Web-based e-mail program such as webmail. The client 120 may support an industry standard for its e-mail client called Multipurpose Internet Mail Extensions (MIME), which is used to send binary file e-mail attachments. Attachments are files that are not part of the e-mail proper, but are sent with the e-mail. At the hand-held, portable electronic device 110, for example, a Messaging Application Programming Interface (MAPI) by Microsoft Windows® may be used to access the Microsoft Exchange e-mail server or to interact with the Microsoft Outlook® client.

According to another illustrative embodiment of the present invention, the client 120 may use a Wireless Application Protocol (WAP) as a secure specification that allows the user 105 to access information instantly via the hand-held, portable electronic device 110 including handheld wireless devices such as mobile phones, pagers, two-way radios, smartphones and communicators. The client 120 may use the WAP as a specification for a set of communication protocols to standardize the way that the hand-held, portable electronic device 110 including wireless devices, such as cellular telephones and radio transceivers may provide Internet access, including e-mail, the World Wide Web, newsgroups, and Internet Relay Chat (IRC). The WAP may specify the use of the Internet at the hand-held, portable electronic device 110 as mobile telephones for using a suitable content format when incorporating Internet applications into mobile networks.

According to yet another illustrative embodiment of the present invention, the client 120 at the hand-held, portable electronic device 110 may be capable of using General Packet Radio Service (GPRS), a packet-based wireless communication service based on Global System for Mobile (GSM) communication that delivers higher data rates and continuous connection to the data services for mobile phone and computer users, as well as telematics applications. The higher data rates may allow the user 105 to send multimedia messages, and interact with multimedia Web sites and similar applications at the hand-held, portable electronic device 110 including mobile handheld devices as well as notebook computers. For example, a General Packet Radio Service may provide speeds up to 115 kilobits per second. The GPRS service may be used to send and receive small bursts of data, such as e-mail and Web browsing, as well as large volumes of data. When based on the GSM standard, the client 120 may enable Enhanced Data GSM Environment (EDGE) and third-generation (3G) mobile telephone services. These 3G services may provide an ability to transfer both voice data (a telephone call) and non-voice data (such as downloading information, exchanging email, and instant messaging) at the hand-held, portable electronic device 110.

According to one illustrative embodiment of the present invention, the client 120 at the hand-held, portable electronic device 110 may further include a baseband processor (not shown) and a processor (not shown) configured to control operations of a radio device at a transceiver. The radio device may provide connectivity to a cellular telephone network (not shown). The user interface (I/F) 145 may communicate user inputs and selections to the processor and the baseband processor for the user APPS. The user interface (I/F) 145 may include a phone interface (I/F) for enabling use of the phone APP. Likewise, the user interface (I/F) 145 may include a PDA interface (I/F) for enabling use of the PDA APP and may further include a GPS interface (I/F) for enabling use of the GPS APP.

For the purposes of enabling a user of the hand-held, portable electronic device 110 to interact with the hand-held, portable electronic device 110, the user interface (I/F) 145 may take a variety of forms including a button(s), keypad, joy stick, touch screen button(s), and dial(s). For example, the user interface (I/F) 145 may include physical hard push buttons and switches located on a body of the hand-held, portable electronic device 110 and provide signals to the user applications running on the processor and/or a telephone control application (APP) executing on the baseband processor.

Consistent with one exemplary embodiment of the present invention, the hand-held, portable electronic device 110 may comprise a handheld or pocket personal computer (PC) application (APP) that includes cell phone technology. The pocket PC APP uses a pocket PC user interface (I/F) for executing computer applications using an operating system (OS) at the hand-held, portable electronic device 110. The hand-held, portable electronic device 110 may comprise a storage device (not shown) for storing the operating system, data, and the computer applications. The storage device may store an application engine to execute the user APPS. A user may store a plurality of media items (e.g., songs) in a file system at the storage device.

The hand-held, portable electronic device 110 may utilize a system data bus to transfer programs and data from the storage device to the processor, in one embodiment of the present invention. Over a link, the system data bus may carry data and commands to/from the processor from/to other devices within the hand-held, portable electronic device 110. For example, the user applications running on the hand-held, portable electronic device 110 send application screens and other data outputs to the user interface (I/F) 145 for display via the system data bus. User inputs may be detected by the user interface (I/F) 145 and sent to the processor on the link via the system data bus.

Consistent with one embodiment, the storage device may comprise a storage disk or a plurality of disks to provide high capacity storage capability for the hand-held, portable electronic device 110. However, portion of the operating system of the hand-held, portable electronic device 110 may be stored on a non-volatile semiconductor memory device (not shown) such as FLASH memory. An example of the memory device is a semiconductor memory such as Random-Access Memory (RAM). In the memory device, the hand-held, portable electronic device 110 may store executables for executing applications (APPS) and associated media content data pertaining to multi-media items in a file system and a cache (not shown). Examples of the media content data include electronic entertainment content and information such as music, video, electronic mail messages.

The system data bus may internally couple the cache, a coder/decoder (CODEC), and a video coder/decoder (VODEC) within the hand-held, portable electronic device 110 to the processor for transferring data therebetween. At the hand-held, portable electronic device 110, the CODEC may be coupled to the storage device, which may, in turn, couple a device speaker and a device microphone to the system data bus. The hand-held, portable electronic device 110 may include one or more communication (COMM) port(s) including a Universal Serial Bus (USB) port and a power and/or charging port. Using the COMM port(s), for example, the hand-held, portable electronic device 110 may interface with external devices, such as computers or a base unit.

The hand-held, portable electronic device 110 may interface with computers, commercial enterprises, media service providers or network operators, Internet service providers and businesses using Internet to obtain and/or disseminate electronic multi-media content (textual, graphic, music and video files) over a connected mesh of wired and/or wireless network users. For example, a user of the hand-held, portable electronic device 110 may access multi-media content and services wirelessly or on wired communication medium on the Internet via websites and web browsers.

For illustrative purposes, in one embodiment, the hand-held, portable electronic device 110 may communicate over a communications system that may be a digital cellular network, although it should be understood that the present invention may be applicable to other systems that support data and/or voice communication. The communications system may allow the hand-held, portable electronic device 110 to communicate with a data network, such as the Internet, through one or more base stations (BTS). The hand-held, portable electronic device 110 may take the form of any of a variety of devices capable of accessing the data network through the BTS. In one embodiment, a plurality of the BTSs may be coupled to a Radio Network Controller (RNC) by one or more connections, such as T1/EI lines or circuits, ATM circuits, cables, optical digital subscriber lines (DSL's), and the like. Generally, the RNC operates to control and coordinate the BTSs to which it is connected. The RNC is, in turn, coupled to a controller (CN) via a connection, which may take on any of a variety of forms, such as T1/EI lines or circuits, ATM circuits, cables, optical digital subscriber lines, and the like.

The network 130 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The network 130 may also include other types of packet-based data networks in further embodiments. Examples of such other packet-based data networks include Asynchronous Transfer Mode (ATM), Frame Relay networks, and the like. As utilized herein, a “data network” may refer to one or more communication networks, channels, links, or paths, and systems or devices (such as routers) used to route data over such networks, channels, links, or paths. It should be understood that the configuration of the communications system may include a network management system (not shown) that provides operation, administration, maintenance, and provisioning functions for a cellular network.

In other embodiments, Bluetooth may enable the hand-held, portable electronic device 100 to communicate over wireless personal area networks (PANs). Bluetooth provides a way to connect and exchange information between devices such as mobile phones, laptops, PCs, printers, digital cameras and video game consoles via a secure, globally unlicensed short-range radio frequency. By using short-range radio frequencies Bluetooth may enable two or more devices, for example, the hand-held, portable electronic device 110 to communicate with another device in close proximity. For example, an audiophone may be a Bluetooth headset capable of transferring files from phones/PDAs to computers. The Bluetooth specification is available from Bluetooth Special Interest Group (SIG) or as IEEE standard 802.15.1. Alternatively, Wi-Fi may be used in the hand-held, portable electronic device 110 to communicate on the same radio frequencies as Bluetooth, but with higher power consumption resulting in a stronger connection. Wi-Fi is sometimes called “Wireless Ethernet”. Bluetooth and/or Wi-Fi may be used in the hand-held, portable electronic device 110 within offices, homes and on the move by setting up networks, printing, or transferring presentations and files from PDAs to computers.

In operation, a user of the hand-held, portable electronic device 110 such as a media player may display a list of available media items on the user interface (I/F) 145 to play a particular media item. By using the user interface (I/F) 145, a user can select one of the available media items. The processor, upon receiving a selection of a particular media item, supplies the media data (e.g., audio file) for the particular media item to the CODEC. The CODEC then produces analog output signals for a speaker. The speaker can be a speaker internal to the hand-held, portable electronic device 110 or external to the hand-held, portable electronic device 110. For example, headphones or earphones that connect to the hand-held, portable electronic device 110 would be considered an external speaker. Accordingly, the processor controls the playing of the particular media item such that upon receiving the user's selection of the particular media item, such as music file in Moving Picture Experts Group (MPEG)-1 Audio Layer 3 (MP3) format or MPEG-4 format based on International Organization for Standardization (ISO)/International Electro-technical Commission (IEC) JTC1/SC29 WG11 standard or M-JPEG used by Internet Protocol (IP) based video cameras via Hypertext Transfer Protocol (HTTP) streams by using multipart and/or mixed content type.

Consistent with one embodiment, the video coder/decoder (VODEC) may be likewise included in the hand-held, portable electronic device 110 to play video items or image files, such as a video file in Windows Media Format (*.wma file) or in a Joint Photographic Experts Group (JPEG) based on JPEG 2000: Image Compression Standards available from International Organization for Standardization (ISO) or MPEG format, or DivX Media Format (*.divx). Another example is a (*.wav), short for Waveform audio format that is a Microsoft and IBM audio file format standard for storing audio on personal computers (PCs). Other examples include the Resource Interchange File Format (RIFF) bit stream format for storing data in “chunks,” the Interchange File Format (IFF) and the Audio Interchange File Format (AIFF) format used on Apple Macintosh computers.

Consistent with one embodiment, a set of base stations may provide wireless connectivity to the hand-held, portable electronic device 110 according to a desirable communication protocol. Examples of a communication protocol include a code division multiple access (CDMA, CDMA2000) protocol, wideband-CDMA (WCDMA) protocol, a Universal Mobile Telecommunication System (UMTS) protocol, a Global System for Mobile communications (GSM) protocol, and like. For example, the hand-held, portable electronic device 110 as a smart phone, text messaging device, and the like may employ a spread spectrum cellular system to operate in a high-speed wireless data network, such as a digital cellular CDMA network.

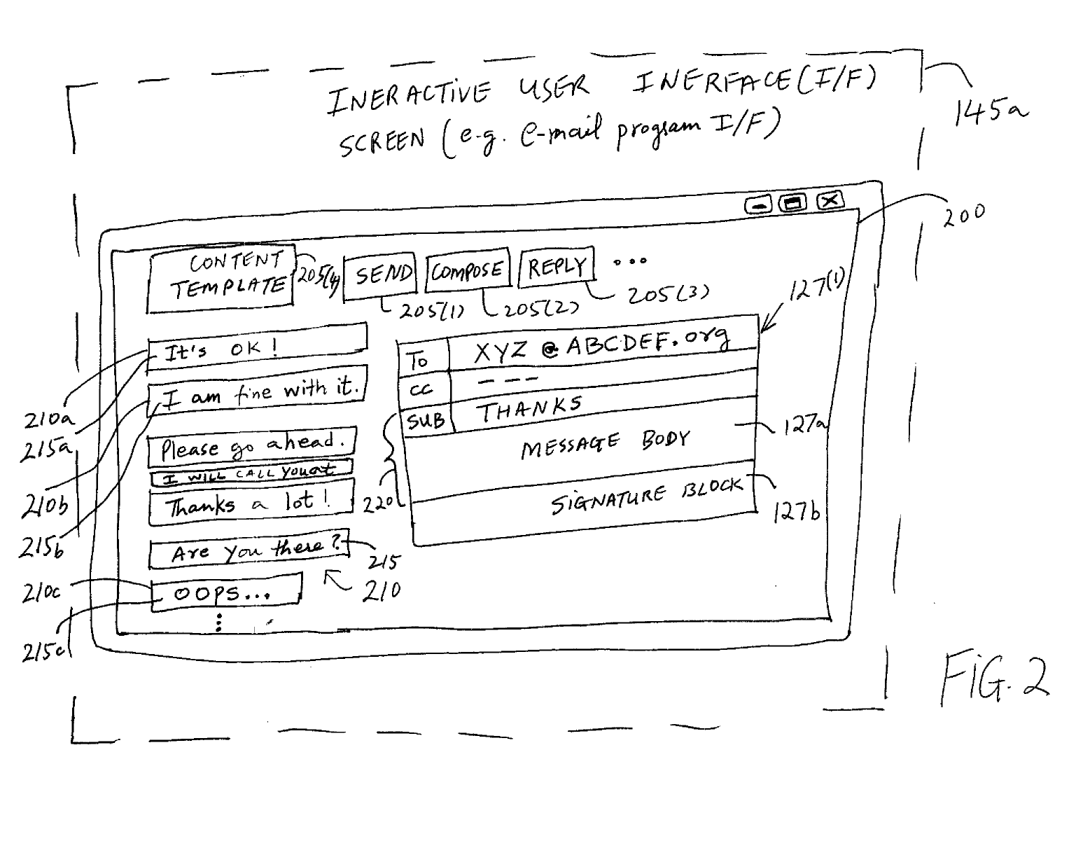

Referring to FIG. 2, an interactive user interface (I/F) screen 145a of the messaging application program 140 shown in FIG. 1 is schematically illustrated consistent with one exemplary embodiment of the present invention. The interactive user interface (I/F) screen 145a may display an e-mail program interface (I/F) generally provided for composing the electronic message 127, such as an electronic mail (e-mail) message using desired message content from at least one of the message templates 115(1-n).

According to one embodiment of the present invention, the user interface (I/F) screen 145a may provide a display window 200 with various features and functions of an e-mail program made available as a set of clickable buttons 205(1-3). For example, the display window 200 may include a first clickable button 205(1) for a mail “SEND” option, a second clickable button 205(2) for a mail “COMPOSE” option, a third clickable button 205(3) for a mail “REPLY” option.

The display window 200 may further include a content template button 205(4). The content template button 205(4) may selectively provide at least one of a first set of templates suitable for composing the message body 127a of the electronic message 127 with generic resendable content or a second set of templates suitable for composing the message body 127a of the electronic message 127 with user populated content. In response to a user command, the content template button 205(4) may provide a plurality of menu preferences to the user 105 for selecting at least one of the first and second set of templates.

In operation, a click by the user 105 on the content template button 205(4) or its selection may provide a set of message templates 210 with precomposed message content 215 for use in the interactive user interface (I/F) screen 145a. The set of message templates 210 may provide at least one of a first template 210a with a user determined content 215a, a second template 210b with a predefined content 215b or a third template 210c with a user editable content 215c for use in the messaging application program 140 capable of communicating with the server 125 in the network 130.

The interactive user interface (I/F) screen 145a may enable the user 105 to compose the message body 127a of the electronic message 127. That is, to compose the message body 127a of the electronic message 127, the display window 200 may enable the user 105 to select the first template 210a with a first predefined content from the set of message templates 210 with the precomposed message content 215.

During an interactive session associated with the user 105, the display window 200 may display the electronic message 127 on the interactive user interface (I/F) screen 145a. For the purposes of enabling the user 105 to compose the message body 127a of the electronic message 127, the client 120 may use the messaging application program 140 that provides the display window 200 at the hand-held, portable electronic device 110. By causing the messaging application program 140 to exchange the electronic message 127 with the server 125 over the network 130, the client 120 may deliver the precomposed message content 215 to an intended recipient.

Upon receiving a reply command, e.g., a click on the third clickable button 205(3) for the mail “REPLY” option from the user 105, the messaging application program 140 may select at least one of the set of templates suitable 210 for composing a first type of electronic message 127(1), such as an electronic mail message to respond to another electronic mail message. Likewise, upon receiving a compose command, e.g., a click on the second clickable button 205(2) for the mail “COMPOSE” option from the user 105, the messaging application program 140 may select at least one of the set of templates 210 suitable for composing a second type of electronic message to send a new electronic mail message.

For providing one or more templates from the set of templates 210 to the user 105 in the display window 200, in one embodiment of the present invention, the messaging application program 140 may provide a response field 220 to form at least one user template created by the user for composing the first type of electronic message 127(1). Alternatively, the messaging application program 140 may provide the response field 220 to form at least a portion of one template of the set of templates 210 for composing the first type of electronic message 127(1) based on at least user created template.

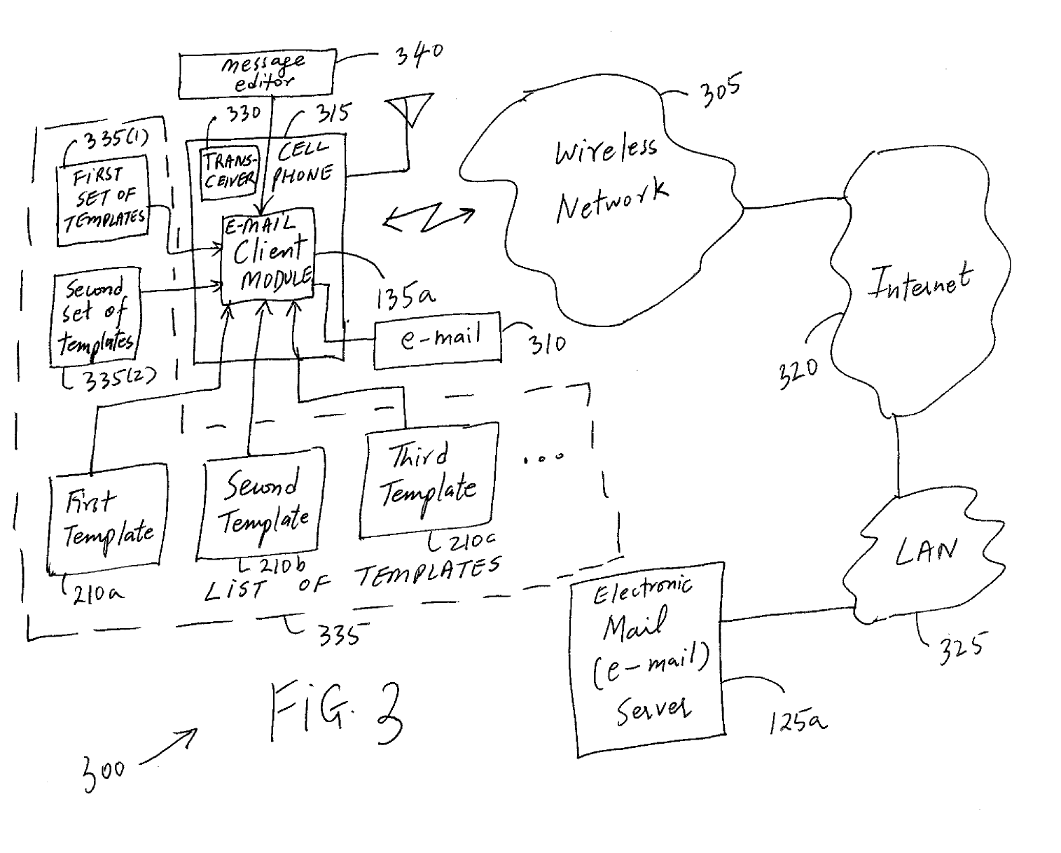

Referring to FIG. 3, a communication system 300 including a wireless network 305 is schematically illustrated to communicate an electronic mail (e-mail) message 310 from a cell phone 315 according to one illustrative embodiment of the present invention. The wireless network 305 may be coupled to the Internet 320, which in turn, may further be coupled to a local area network (LAN) 325. To provide an e-mail service, the communication system 300 may include a mail server, such as an e-mail server 125a coupled to the LAN 325.

Consistent with one exemplary embodiment of the present invention, the cell phone 315 may include an e-mail client module 135a of the messaging application program 140 capable of communicating with a mail server, such as an e-mail server 125a. According to one illustrative embodiment of the present invention, the cell phone 315 may further include a baseband processor (not shown) and a processor (not shown) configured to control operations of a radio device at a transceiver 330. The radio device may provide connectivity to the wireless network 305, such as a cellular telephone network.

Pursuant to one exemplary embodiment of the present invention, the e-mail client module 135a may enable use of a list of templates 335 and may selectively provide at least one of a first set of templates 335(1) suitable for composing the message body 127a of the e-mail message 310 with generic resendable content or a second set of templates 335(2) suitable for composing the message body 127a of the e-mail message 310 with user populated content. In response to a user command, the e-mail client module 135a may provide a plurality of menu preferences to the user 105 for selecting at least one of the first and/or second set of templates 335(1,2).

Consistent with one exemplary embodiment of the present invention, the cell phone 315 may further include a message editor 340 for composing the message body 127a of the e-mail message 310. The message editor 340 may enable incorporation of the first set of templates 335(1) with generic resendable content or editing of the second set of templates 335(2) with user populated content.

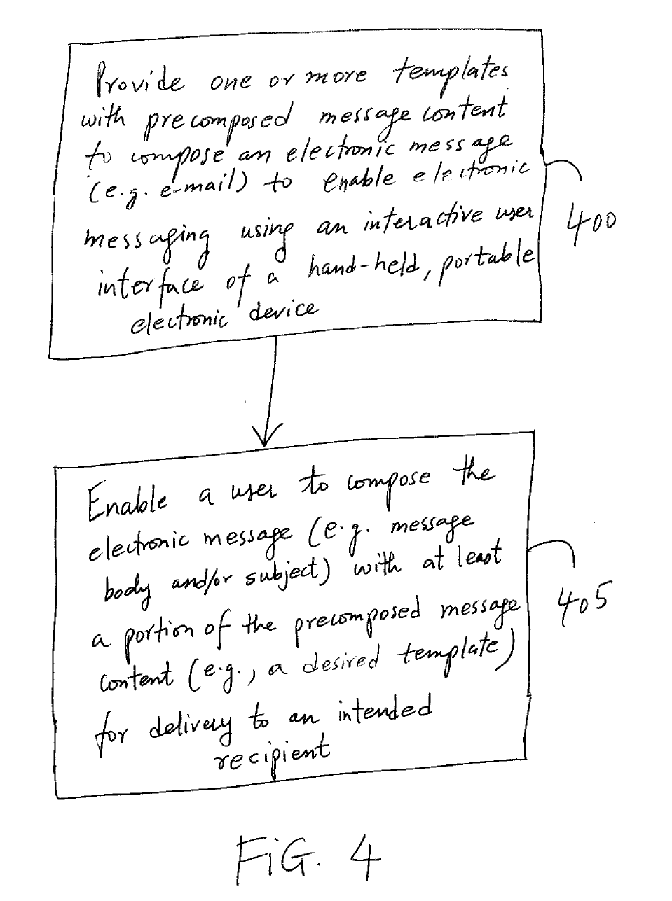

Referring to FIG. 4, a stylized representation for implementing a method of enabling electronic messaging using the interactive user interface (I/F) screen 145a shown in FIG. 2 of the hand-held, portable electronic device 110 shown in FIG. 1 is schematically illustrated in accordance with an exemplary embodiment of the present invention. At block 400, the messaging application program 140 may provide one or more templates of the message templates 115(1-n) or the set of template 210 or the list of templates 335 with precomposed message content for use in the interactive user interface (I/F) screen 145a to compose the electronic message 127 having at least one of the message body 127a or the signature block 127b. At block 405, the interactive user interface (I/F) screen 145a may enable the user 105 to compose the message body 127a of the electronic message 127 with at least a portion of the precomposed message content 215 for delivery to an intended recipient. The interactive user interface (I/F) screen 145a may present the set of templates 210 to the user 105.

In one embodiment, the user 105 may be able to set a priority as to which message templates 115 or 210 or 335 to be made available first on the interactive user interface (I/F) screen 145a. Alternatively, the messaging application program 140 may determine which message templates 115 or 210 or 335 to be made available first on the interactive user interface (I/F) screen 145a. For example, based on a criteria indicative of usage of certain message template 115 or 210 or 335 over others may determine which one that get displayed or made available first to the user 105 upon an indication to use one or more of the message templates 115(1-n) or the set of template 210 or the list of templates 335. In this way, the messaging application program 140 may provide a desired template of message content to the user 105 for composing the electronic message 127, such as the e-mail 310 with at least a portion of the precomposed message content 215.

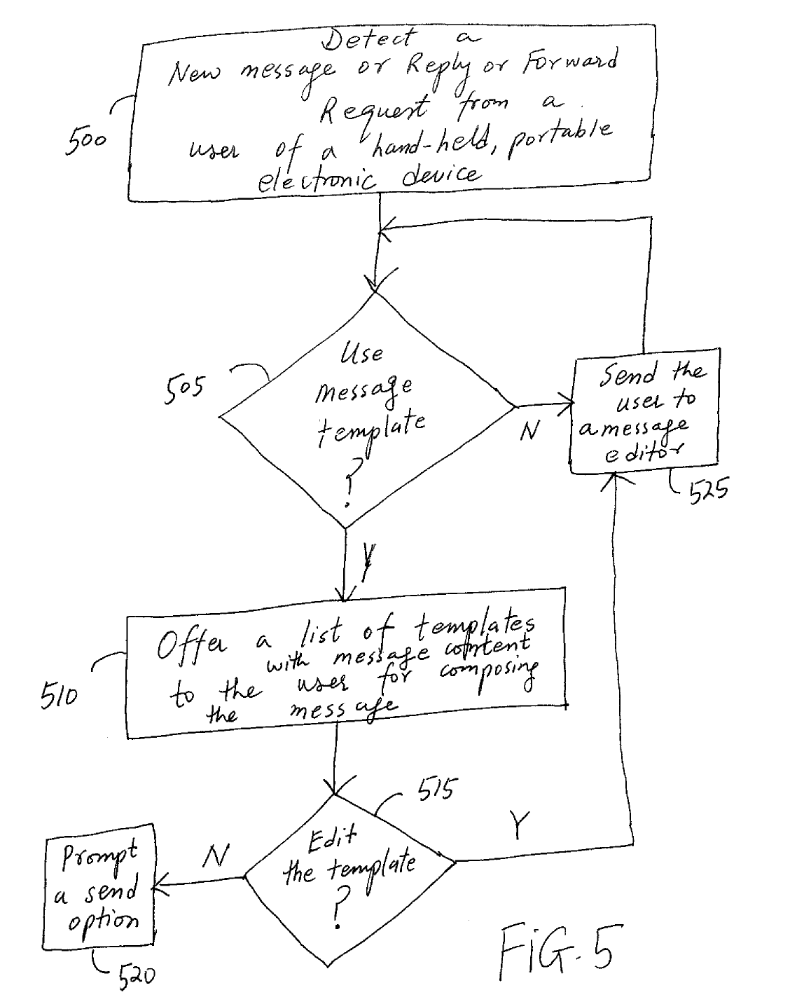

Referring to FIG. 5, a stylized representation for implementing a method of selectively providing the list of templates 210 suitable is schematically illustrated for composing the electronic message 127 using generic or user populated content consistent with an illustrative embodiment of the present invention. At block 500, the messaging application program 140 may detect a new message or reply or forward request from a user of the hand-held, portable electronic device 110 shown in FIG. 1. For example, the messaging application program 140 may detect a click or selection of the first clickable button 205(1) for a mail “SEND” option, the second clickable button 205(2) for a mail “COMPOSE” option, or the third clickable button 205(3) for a mail “REPLY” option, as shown in FIG. 2.

At a decision block 505, the messaging application program 140 may determine if the user 105 intends to use a message template 115 in response to a click or selection of one of the first, second, third clickable buttons 205(1-3). If so, at block 510, the messaging application program 140 may offer the list of templates 335 with message content to the user 105 for composing the electronic message 127. At a decision block 515, the messaging application program 140 may determine if the user 105 intends to edit the selected template 210c. The message editor 340 shown in FIG. 3 may be deployed by the user to compose or edit the selected template 210c. In one embodiment, the message editor 340 is the same editor which enables the user 105 to compose the electronic message 127. In another embodiment, a separate editor may be used to compose the electronic message 127.

When at the decision block 515 no editing of the selected template 210c is desired by the user 105 the messaging application program 140 may prompt the user 105 with a send option at block 520 for sending the electronic message 127 to an intended recipient. For example, a click or selection of the first clickable button 205(1) for a mail “SEND” option may be used to send the electronic message 127 for delivery to the intended recipient. Conversely, if editing of the selected template 210c is desired by the user 105, the messaging application program 140 may send or prompt the user 105 to use the message editor 340, as shown at block 525. After editing of the selected template 210c to compose the electronic message 127, the messaging application program 140 may determine whether use of another message template is desired, at the decision block 505. Likewise, at the decision block 515, if use of another message template is desired without a need to edit the selected template 210c, the messaging application program 140 may offer the list of templates 335 with message content to the user 105 for composing the electronic message 127.

In this manner, for example, the user 105 may compose the e-mail message 310 using the messaging application program 140 without having the user 105 to create the electronic message 127, i.e., the message body 127a from scratch by entering information such as text from a keyboard and/or a pointing device, such as a mouse. For example, even when using a laptop computer or a device having a computer keyboard with access to a pointing device, such as a mouse the electronic message 127, i.e., the message body 127a may not be drafted from scratch. In a wireless e-mail scenario, however, when using the hand-held, portable communication device 110, such as the cell phone 315 having a typical mobile keyboard it may become convenient and a relatively fast process to compose the e-mail message 310 not from the scratch by inputting or typing in the entire message content.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method of enabling electronic messaging using an interactive user interface of a hand-held, portable electronic device, the method comprising:
providing one or more templates with precomposed message content for use in said interactive user interface to compose an electronic message having at least one of a message body or a signature block; and
enabling a user to compose said message body of said electronic message with at least a portion of said precomposed message content for delivery to an intended recipient.

2. The method, as set forth in claim 1, wherein providing one or more templates with precomposed message content for use in said interactive user interface further comprises:
providing at least one of a first template with a user determined content, a second template with a predefined content or a third template with a user editable content for use in a messaging application capable of communicating with a server in a network.

3. The method, as set forth in claim 1, wherein enabling a user to compose said message body of said electronic message further comprises:
enabling a user to select a first template with a first predefined content from said one or more templates with precomposed message content in said interactive user interface to compose said message body of said electronic message; and
selectively providing at least one of a first set of templates suitable for composing said message body of said electronic message with generic resendable content or a second set of templates suitable for composing said message body of said electronic message with user populated content.

4. The method, as set forth in claim 3, wherein enabling a user to compose said message body of said electronic message further comprises:
causing a client of said messaging application to enable a display at said hand-held, portable electronic device coupled to said server over said network; and
causing said messaging application to exchange said electronic message with said server over said network for delivery of said precomposed message content to said intended recipient.

5. The method, as set forth in claim 3, wherein enabling a user to compose said message body of said electronic message further comprises:
displaying said electronic message on a screen during an interactive session associated with said user; and
in response to a user command, providing a plurality of menu preferences to said user for selecting at least one of said first and second set of templates.

6. The method, as set forth in claim 2, further comprising:
receiving a reply command from said user selecting at least one of said one or more templates suitable for composing a first type of said electronic message to respond to an electronic mail message.

7. The method, as set forth in claim 2, further comprising:
receiving a compose command from said user selecting at least one of said one or more templates suitable for composing a second type of said electronic message to send an electronic mail message.

8. The method, as set forth in claim 2, wherein providing one or more templates further comprises:
providing a response field to form at least one user template by said user for composing said electronic message.

9. The method, as set forth in claim 2, wherein providing one or more templates further comprises:
providing a response field to form at least a portion of one template of said one or more templates for composing said electronic message based on at least user template.

10. An article comprising a computer readable storage medium storing instructions that, when executed cause a client-server system to enable electronic messaging using an interactive user interface of a hand-held, portable electronic device to:
provide one or more templates with precomposed message content for use in said interactive user interface to compose an electronic message having at least one of a message body or a signature block; and
enable a user to compose said message body of said electronic message with at least a portion of said precomposed message content for delivery to an intended recipient.

11. The article, as set forth in claim 10, comprising a medium storing instructions that, when executed cause a client-server system to:
provide at least one of a first template with a user determined content, a second template with a predefined content or a third template with a user editable content for use in a messaging application capable of communicating with a server in a network.

12. The article, as set forth in claim 11, comprising a medium storing instructions that, when executed cause a client-server system to:
enable a user to select a first template with a first predefined content from said one or more templates with precomposed message content in said interactive user interface to compose said message body of said electronic message; and
selectively provide at least one of a first set of templates suitable for composing said message body of said electronic message with generic resendable content or a second set of templates suitable for composing said message body of said electronic message with user populated content.

13. The article, as set forth in claim 12, comprising a medium storing instructions that, when executed cause a client-server system to:
cause a client of said messaging application to enable a display at said hand-held, portable electronic device coupled to said server over said network; and
cause said messaging application to exchange said electronic message with said server over said network for delivery of said precomposed message content to said intended recipient.

14. The article, as set forth in claim 12, comprising a medium storing instructions that, when executed cause a client-server system to:
display said electronic message on a screen during an interactive session associated with said user; and
in response to a user command, provide a plurality of menu preferences to said user for selecting at least one of said first and second set of templates.

15. The article, as set forth in claim 11, comprising a medium storing instructions that, when executed cause a client-server system to:
receive a reply command from said user selecting at least one of said one or more templates suitable for composing a first type of said electronic message to respond to an electronic mail message.

16. The article, as set forth in claim 15, comprising a medium storing instructions that, when executed cause a client-server system to:
receive a compose command from said user selecting at least one of said one or more templates suitable for composing a second type of said electronic message to send an electronic mail message.

17. The article, as set forth in claim 11, comprising a medium storing instructions that, when executed cause a client-server system to:
provide a response field to form at least one user template by said user for composing said electronic message.

18. The article, as set forth in claim 11, comprising a medium storing instructions that, when executed cause a client-server system to:
provide a response field to form at least a portion of said template of said plurality of templates for composing said electronic message based on at least user template.

19. A client-server system for enabling electronic messaging using an interactive user interface of a hand-held, portable electronic device, the client-server system including a client comprising:
a controller;
a storage device coupled to said controller for storing one or more templates with precomposed message content for use in said interactive user interface to compose an electronic message having at least one of a message body or a signature block; and
a messaging application capable of communicating with a server in a network for enabling a user of said hand-held, portable electronic device to compose said message body of said electronic message with at least a portion of said precomposed message content for delivery to an intended recipient.

20. The client-server system, as set forth in claim 19, wherein said storage device further storing at least one of a first template with a user determined content, a second template with a predefined content or a third template with a user editable content for use in said messaging application.
